(19) United States
(12) Patent Application Publication
(10) Pub. No.: US 2015/0347004 A1
(43) Pub. Date: Dec. 3, 2015

(54) INDIC LANGUAGE KEYBOARD INTERFACE

(71) Applicant: Man Mohan Garg, Manhattan Beach, CA (US)

(72) Inventor: Man Mohan Garg, Manhattan Beach, CA (US)

(21) Appl. No.: 14/289,369

(22) Filed: May 28, 2014

(51) Int. Cl. G06F 3/0488; G06F 3/0489; G06F 3/0484; G06F 3/041; G06F 3/0482

(52) U.S. Cl. CPC G06F 3/04886; G06F 3/0412; G06F 3/0416; G06F 3/0482; G06F 3/04842; G06F 3/04883; G06F 3/04897

(57) ABSTRACT

A keyboard layout is presented that includes Indic language consonants arranged according to their phonetic principles. A user may type Indic language characters using a combination of a key selection and a gesture. For example, the user may select a consonant by selecting one of the keys on the keyboard. While the key is still selected, the user may modify the consonant by performing a gesture using a touch interface, where the gesture originates from the selected key and a path of the gesture corresponds with the desired modifier. Thus, the selection of the key and the gesture action may be performed by the user in one motion or stroke. The modified consonant may then be displayed.

### BACKGROUND

Standard keyboards include keys that are associated with the Roman alphabet. These keyboards are generally used to type non-Roman alphabet letters as well. However, typing non-Roman alphabet letters using standard keyboards can be difficult. For example, the Roman alphabet includes twenty-six letters. Languages that do not use the Roman alphabet, though, may include fewer or more letters. In cases in which a language includes more letters, non-letter keys (e.g., the F1 key, the “Home” key, the number keys etc.) may be repurposed as letter keys, or multiple keys may need to be selected to generate one letter (e.g., the alt key in combination with a letter key). Repurposing keys, requiring the selection of a combination of keys, and/or the like may negatively affect efficiency and the user experience.

### SUMMARY

As described above, typing non-Roman alphabet letters using standard keyboards can be difficult. Accordingly, the embodiments described herein present systems and methods for typing Indic language text. A keyboard layout is presented that includes Indic language consonants arranged according to their phonetic principles. The keys of the keyboard may be visible on a touch interface. A user may type Indic language characters using a combination of a key selection and a gesture. For example, the user may select a consonant by selecting one of the keys on the keyboard (e.g., via the touch interface). While the key is selected, the user may modify the consonant by performing a gesture using the touch interface. The gesture may originate from the selected key and a path of the gesture may correspond with the desired modifier. The modified consonant may then be displayed. In this way, the keyboard and techniques described herein may allow for a smaller keyboard that fits on one screen, may allow the user to type in a more natural manner, and/or may reduce the latency associated with typing Indic languages.

One aspect of the disclosure provides a non-transitory computer-readable medium having stored thereon executable program instructions that direct a computing device to perform a process that comprises detecting a gesture performed by the user on a touch screen of the computing device, where the gesture originates at a first location on the touch screen, wherein the gesture is associated with a modifier, and where the first location is associated with a first key of a keyboard, and wherein the first key is associated with a first character having a first sound. The executable program instructions further direct the computing device to perform a process that comprises, in response to the gesture, displaying a modified version of the first character, where the first character is modified based on the modifier associated with the gesture, and where the modified version of the first character has a second sound different from the first sound.

Another aspect of the disclosure provides a keyboard for providing inputs to a computing device. The keyboard comprises a housing comprising a first cavity. The keyboard further comprises a touch interface coupled to a bottom portion of the first cavity, where the touch interface is configured to detect touch events provided by a user. The keyboard further comprises a film coupled to a top portion of the touch interface, where the film comprises an outline of a first key associated with a first character at a first location on the touch interface, where the first character has a first sound, where the touch interface is further configured to indicate to the computing device that a modified version of the first character is selected for display in response to a detection of a gesture that originates at the first location, and where the modified version of the first character has a second sound different from the first sound.

Another aspect of the disclosure provides a computer-implemented method of generating text for display on a computing device. The method comprises, as implemented by a mobile device comprising a touch interface, the mobile device configured with specific executable instructions, displaying, in a first area, a keyboard, where the keyboard comprises a first key associated with a first character, where the first character is associated with a first sound, and where the first key is displayed at a first location on the touch interface. The method further comprises receiving an indication of a touch event, where the touch event originates at the first location. The method further comprises displaying, in a second area, a modified version of the first character in response to receiving the indication of the touch event, where the modified version of the first character is associated with a second sound that is different than the first sound.

Another aspect of the disclosure provides a system comprising a network interface. The system further comprises a touch interface. The system further comprises a first computing system comprising one or more computing devices, the first computing system in communication with the network interface and the touch interface and programmed to implement a keyboard display engine configured to display a keyboard, where the keyboard comprises a first key associated with a first character, where the first character is associated with a first sound, and where the first key is displayed at a first location on the touch interface. The first computing system may be further programmed to implement a touch event engine configured to receive an indication of a touch event detected by the touch interface, where the touch event originates at the first location. The first computing system may be further programmed to implement a device controller configured to instruct the network interface to transmit a command to a second computing system via a network in response to receiving the indication of the touch event, where the command comprises an instruction to display a modified version of the first character, and where the modified version of the first character is associated with a second sound that is different than the first sound.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIGS. 1A-1C illustrate example environments in which an Indic language keyboard or keypad can be used to generate text on a user device.

FIG. 2 illustrates an Indic language text generating process that may be implemented by a user device associated with an Indic language keyboard or keypad.

FIG. 3 illustrates a table depicting gestures associated with the modification of an Indic language consonant.

FIG. 4 illustrates an example representation of an Indic language keyboard or keypad interface for use on a user device, such as the second user device of FIG. 1B or the third user device of FIG. 1C.

FIGS. 5A-5E illustrate an example of a user device that provides an Indic language keyboard or keypad interface.

### DETAILED DESCRIPTION

### Introduction

As described above, typing non-Roman alphabet letters using standard keyboards can be difficult. This may be especially true when attempting to type Indic language (e.g., a language originating on the Indian subcontinent, such as Hindi, Urdu, Bengali, Punjabi, Marathi, Gujarati, etc.) letters using standard keyboards. Indic languages are different from the English language, for example, in that Indic languages use modifiers instead of a combination of characters for adding a vowel sound to a consonant. In English, vowels are placed next to a consonant to modify the consonant's sound. Thus, standard keyboards include keys associated with consonants and keys associated with vowels (e.g., standard keyboards include keys for each letter in the alphabet).

However, in Indic languages, a modifier or marking (referred to as a “Matra”) is applied to the consonant to indicate that the consonant's sound has been modified. In general, a modifier or marking changes an appearance of the consonant when applied to the consonant. For example, the Hindi language consonant [symbol] sounds like “ [symbol] .” In order to make the consonant sound like “Ki” (pronounced like the k in “key”), a modifier or marking is applied to the consonant such that the consonant is modified to look like the following: [symbol] . Indic languages may include thirty-three or more consonants and nine or more modifiers, where each modifier can be applied to each consonant letter. Thus, an Indic language could have more than 297 possible combinations of consonants and modifiers. Standard keyboards, whether physical keyboards or virtual keyboards, do not include enough keys such that each combination could be uniquely selected with one key selection. While a standard keyboard could be modified to include 297 keys, such a modified keyboard may be too large for a user to quickly and efficiently find the appropriate key and type the desired text. In fact, in the case of a virtual keyboard, all of the keys may not even fit on a screen unless the keys are sized such that they are too small to recognize and/or select accurately.

Some techniques have been developed to alleviate these problems; however these techniques introduce additional issues that degrade the user experience. For example, virtual keyboards displayed by computing devices (e.g., keyboards displayed on a screen that have keys that can be selected via a mouse or touch interface) can include a plurality of pages. Each page of the virtual keyboard may include a different set of keys, thereby allowing the keyboard to include keys that are not sized too small to recognize and/or select accurately even while including a large number of keys. Thus, a virtual keyboard could include several pages of keys to cover each possible combination of consonants and modifiers. However, this technique may necessitate introducing tens of pages, which can make finding the appropriate key very time consuming.

Furthermore, the order of letters in Indic languages may be based on phonetic principles that take into account the manner and place of articulation of the consonant or vowel that the respective letter represents. Having the various combinations of consonants and modifiers laid out in separate pages may disrupt this order.

As another example, a modified keyboard could include just the consonants and modifiers. To modify a consonant, a user could select the consonant and then select the appropriate modifier. The number of consonants and modifiers may exceed forty-three, which again would necessitate a keyboard to include a larger number of alphabet keys than what is currently found on standard keyboards. As described above, a virtual keyboard could include a plurality of pages to cover all alphabet keys, but the same latency issues may occur. In fact, the latency issues may be exacerbated because a user may have to switch back and forth between pages each time the user wishes to modify the sound of a consonant.

Accordingly, the embodiments described herein include systems and methods for typing Indic language text while reducing or minimizing the effects of the issues described above. As described herein, a keyboard layout is presented that includes Indic language consonants arranged according to the phonetic principles discussed above. The keys of the keyboard may be visible on a touch interface. A user may type Indic language characters using a combination of a key selection and a gesture. For example, the user may select a consonant by selecting one of the keys on the keyboard (e.g., via the touch interface). A preview of the selected consonant may be displayed in a key on the keyboard referred to herein as an echo key. While the key is selected, the user may modify the consonant by performing a gesture (e.g., using the touch interface). The gesture may originate from the selected key and a path of the gesture may correspond with the desired modifier. In some embodiments, a gesture that corresponds with a modifier may be related to or match the shape of the modifier to make typing the Indic language text more intuitive for the user. Thus, the selection of the key and the gesture action may be performed by the user in one motion or stroke (e.g., a gesture that originates at a key may be considered a selection of the key and a gesture to modify a consonant associated with the key). The modified consonant may be displayed in the echo key until, for example, the gesture is complete (e.g., the user releases his or her finger from the touch interface), at which point the modified consonant may be displayed. In this way, the keyboard and techniques described herein may allow for a smaller keyboard that fits on one screen, may allow the user to type in a more natural manner, and/or may reduce the latency associated with typing Indic languages.

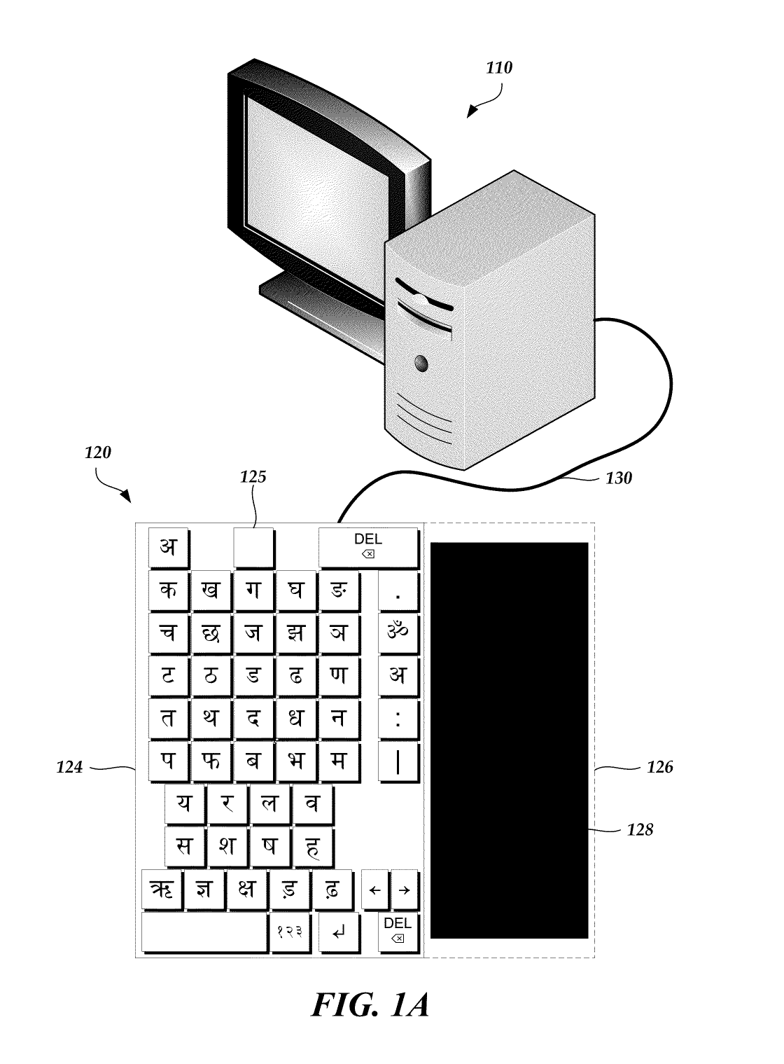

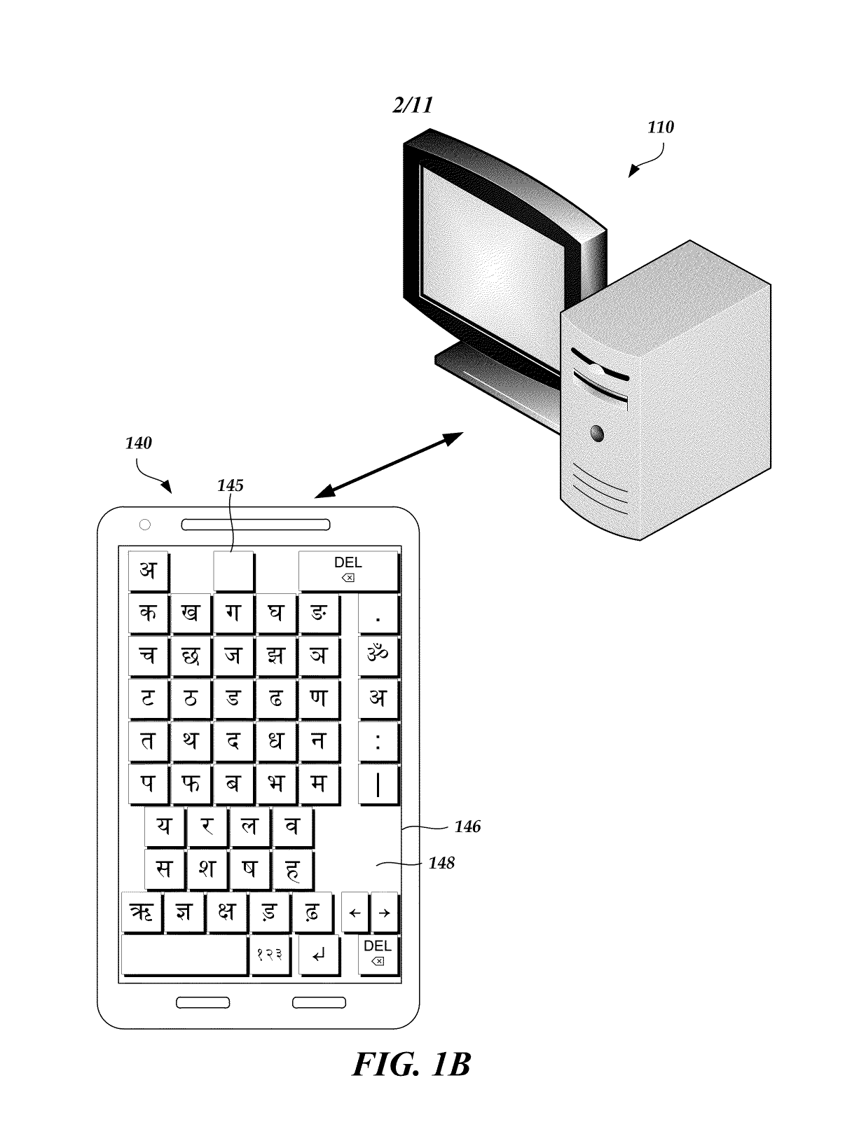

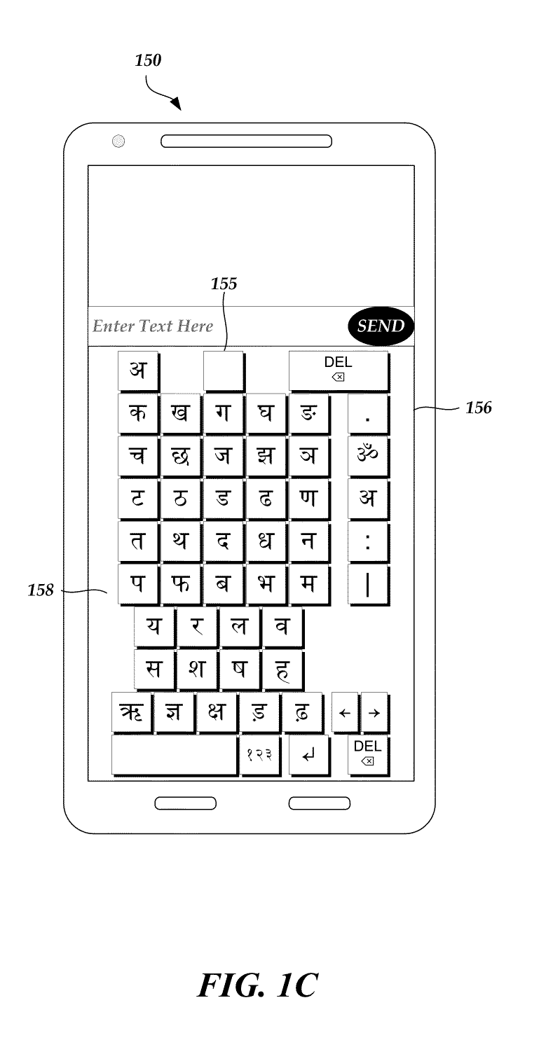

As described in greater detail below with respect to FIGS. 1A-1C, the techniques described herein may be implemented in various embodiments. For example, a physical keyboard or keypad can be constructed that includes keys associated with the consonants of an Indic language overlaid over a touch interface. Thus, a user may select a consonant by, for example, tapping the touch interface at the location of the appropriate key. The physical keyboard or keypad may be coupled to a computing device (e.g., a laptop, a desktop, a tablet, a mobile phone, etc.) to allow a user to type in the Indic language. As another example, an application that includes a virtual keyboard can be installed on a computing device that includes a touch interface. While running the application, the computing device can execute commands to display the virtual keyboard, detect touch events (e.g., the selection of a key, a gesture, etc.), and transmit instructions to a second computing device (e.g., via a wired or wireless connection) that cause the second computing device to display the typed text. As another example, a virtual keyboard can be installed as a keyboard interface on a computing device that includes a touch interface. The computing device can execute commands to display the virtual keyboard in place of the computing device's standard keyboard in a first window or area, detect touch events, and display the typed text in a second window or area (e.g., in an application that is in focus on the computing device).

In some embodiments, a plurality of gestures can be performed to modify a consonant. For example, the selection of a consonant key may be followed by two separate gestures that, when performed in combination, correspond with a specific modifier. When the combination of gestures is detected (e.g., in order or in any order), then the consonant may be modified. As another example, gestures may be used in the alternative such that one or more gestures can be performed to modify a consonant in the same way.

A computing device may further provide a visual, audible, or sensory or haptic feedback to indicate that a gesture has been detected and/or a consonant has been modified. For example, a consonant may be highlighted, may change colors, may glow, and/or the like to indicate that a gesture has been detected and/or the respective consonant has been modified. As another example, the computing device may make a sound (e.g., a beep, a click, etc.) when a gesture is detected and/or a consonant is modified. As another example, the computing device may vibrate when a gesture is detected and/or a consonant is modified.

If a user makes a mistake or otherwise would like to change the modifier applied to a consonant, the user in some embodiments can highlight the appropriate consonant or use arrow keys to navigate a cursor to the appropriate consonant. The keyboard may include an echo key that echoes (e.g., displays) the last modified consonant and, when selected, indicates to a computing device that any modifier applied to a consonant is to be removed and/or a new modifier is to be applied. While the echo key is selected, the user may perform a gesture, which causes the computing device to apply a new modifier to the consonant (e.g., to replace an old modifier).

While the techniques described herein are discussed with respect to touch interfaces, this is not meant to be limiting. The techniques described herein may apply even if a touch interface is not available. For example, a user can use a mouse or other pointing device to mimic a gesture motion by pressing on a mouse button to indicate that the gesture motion is beginning and releasing the mouse button to indicate that the gesture motion is complete.

Merely for convenience and illustrative purposes, the techniques described herein are discussed in conjunction with the Devanagari script, and the Hindi language in particular. However, the techniques described herein are not so limited and may be applied to any Indic language and script. In addition, the Indic language characters displayed as a result of the performance of the techniques described herein may correspond to the standard Unicode character set. In some embodiments, the techniques described herein may be applied to any language that includes letters and modifiers or markings that are used to modify the pronunciation of letters.

### System Diagrams

FIGS. 1A-1C illustrate example environments in which an Indic language keyboard or keypad can be used to generate text on a user device. As illustrated in FIG. 1A, a physical keyboard 120 is coupled to a user device 110. The user device 110 can include a wide variety of computing devices, including personal computing devices, terminal computing devices, laptop computing devices, tablet computing devices, electronic reader devices, mobile devices (e.g., mobile phones, media players, handheld gaming devices, etc.), wearable devices with network access and program execution capabilities (e.g., “smart watches” or “smart eyewear”), wireless devices, set-top boxes, gaming consoles, entertainment systems, televisions with network access and/or program execution capabilities (e.g., “smart TVs”), and various other electronic devices and appliances.

In an embodiment, the keyboard 120 includes a section or partition 124. The section 124 may include a cavity, where a touch interface is coupled to a bottom portion of the cavity. The touch interface may include an outline of a set of keys that correspond with consonants of an Indic language overlaying the touch interface. For example, a thin material (e.g., a film, a sticker, etc.) may be applied to a top portion of the touch interface or an image may be printed onto the top portion of the touch interface, where the thin material or image includes the outline of the set of keys. The keys may be arranged in a fashion such that the consonants are laid out according to the phonetic principles described above. The section 124 may further include additional keys, such as for special characters, navigation, system commands, deleting text, modifying text, and/or the like.

In an alternate embodiment, the keyboard 120 may include two sections or partitions: section 124 and section 126. The section 124 may not include a touch interface, but rather may include a set of physical keys that correspond with consonants of an Indic language. The keys may be arranged in a fashion such that the consonants are laid out according to the phonetic principles described above. The section 124 may further include additional keys, such as for special characters, navigation, system commands, deleting text, modifying text, and/or the like. The section 126 may include a touch interface 128. The keyboard 120 may further include other sections, not shown (e.g., a number pad). While the section 124 is illustrated as being coupled to the left side of the section 126, this is not meant to be limiting. The section 124 and the section 126 may be arranged in any manner and/or combined into one section (e.g., the touch interface 128 may separate some keys in the section 124 from other keys in the section 124).

The keyboard 120 may be coupled to the user device 110 via a wired connection 130 (e.g., the keyboard 120 and the user device 110 may be coupled via a universal serial bus (USB) interface). In other embodiments, not shown, the keyboard 120 is coupled to the user device 110 via a wireless connection (e.g., Bluetooth, RF, infrared, Wi-Fi, etc.).

In an embodiment, a user uses the keyboard 120 to provide inputs to the user device 110. For example, if the section 124 includes a touch interface, the user can select a key corresponding to a consonant by pressing down on the touch interface at the location of the outline of the desired key. A preview of the selected consonant may be displayed in the touch interface at a location of an outline of echo key 125. While still pressing down on the touch interface, the user may then provide a gesture associated with a modifier, where the gesture originates from the location of the outline of the desired key. Thus, the selection of the key and the gesture action may be performed by the user in one motion or stroke (e.g., a gesture that originates at the location of the outline of the desired key may be considered a selection of the key and a gesture to modify a consonant associated with the key). A preview of the consonant as modified by the modifier associated with the gesture may be displayed at the location of the outline of the echo key 125 (e.g., until the user releases his or her finger, which completes the gesture). The keyboard 120 may be configured to transmit a message to the user device 110, where the message indicates that the modified consonant is selected for display (e.g., indicates the selection of a character associated with a specific Unicode value), when the user releases and is no longer touching the touch interface. In response to receiving the message, the user device 110 (e.g., the operating system, a specific application, etc.) may display the modified consonant.

As another example, if the section 124 includes physical keys, the user can select a key corresponding to a consonant in the section 124. The user may then use the touch interface 128 to provide a gesture associated with a modifier. Once the gesture is complete, the keyboard 120 may be configured to transmit a message to the user device 110, where the message indicates that the modified consonant is selected for display (e.g., indicates the selection of a character associated with a specific Unicode value). In response to receiving the message, the user device 110 (e.g., the operating system, a specific application, etc.) may display the modified consonant.

In other embodiments, not shown, the section 124 includes physical keys and the keyboard 120 does not include the section 126. For example, the keyboard 120 may be used in conjunction with a mouse or other pointing device that provides the gesture movement. As another example, the display of the user device 110 may include a touch interface or a touch interface may be available as a standalone device. The keyboard 120 can be used in conjunction with the display of the user device 110 and/or the standalone device to provide the gesture.

As illustrated in FIG. 1B, a second user device 140 is in communication with the user device 110. The second user device 140 can include a wide variety of computing devices, including personal computing devices, terminal computing devices, laptop computing devices, tablet computing devices, electronic reader devices, mobile devices (e.g., mobile phones, media players, handheld gaming devices, etc.), wearable devices with network access and program execution capabilities (e.g., “smart watches” or “smart eyewear”), wireless devices, set-top boxes, gaming consoles, entertainment systems, televisions with network access and/or program execution capabilities (e.g., “smart TVs”), and various other electronic devices and appliances. The second user device 140 may include a touch interface 146.

In an embodiment, the second user device 140 is configured to execute an application that displays a virtual keyboard interface 148. Alternatively, the virtual keyboard interface 148 may be embodied within the operating system of the second user device 140, in which case the virtual keyboard interface 148 may be available in any application. As with the keyboard 120 of FIG. 1A, the application may display the virtual keyboard interface 148, which includes a set of keys that correspond with consonants of an Indic language. The keys may be arranged in a fashion such that the consonants are laid out according to the phonetic principles described above. The virtual keyboard interface 148 may further include additional keys, such as for special characters, navigation, system commands, deleting text, modifying text, and/or the like.

The second user device 140 may be in communication with the user device 110 via a wireless connection (e.g., Bluetooth, RF, infrared, Wi-Fi, etc.). In other embodiments, not shown, the second user device 140 is in communication with the user device 110 via a wired connection (e.g., via a universal serial bus (USB) interface).

The second user device 140 may associate with a user device based on the proximity of the selected user device to the second user device 140. For example, the second user device 140 may associate with the closest user device that has the features necessary to establish a connection (e.g., with the closest user device that can receive Bluetooth communications). As another example, the second user device 140 may associate with any user device selected by the user that is in range of the second user device 140. Thus, the user device 110 may be the user device closest to the second user device 140 and/or the user device selected by the user.

In an embodiment, a user uses the second user device 140 to serve as a remote device that provides inputs to the user device 110. For example, the user can select a key corresponding to a consonant using the touch interface 146. The application executed by the second user device 140 may be configured to display a preview of the appropriate consonant in echo key 145. While the key is still selected (e.g., while the user is still pressing down on the touch interface 146), the user may use the touch interface 146 to provide a gesture associated with a modifier, where the gesture originates from the selected key. Thus, the selection of the key and the gesture action may be performed by the user in one motion or stroke (e.g., a gesture that originates at a key may be considered a selection of the key and a gesture to modify a consonant associated with the key). The echo key 145 may display a preview of the modified consonant after the gesture is performed and/or until the user is no longer touching the touch interface 146. The application executed by the second user device 140 may be configured to transmit a message to the user device 110, where the message instructs the user device 110 to display the modified consonant.

As illustrated in FIG. 1C, a third user device 150 is depicted. The third user device 150 can include a wide variety of computing devices, including personal computing devices, terminal computing devices, laptop computing devices, tablet computing devices, electronic reader devices, mobile devices (e.g., mobile phones, media players, handheld gaming devices, etc.), wearable devices with network access and program execution capabilities (e.g., “smart watches” or “smart eyewear”), wireless devices, set-top boxes, gaming consoles, entertainment systems, televisions with network access and/or program execution capabilities (e.g., “smart TVs”), and various other electronic devices and appliances. The third user device 150 may include a touch interface 156.

In an embodiment, the third user device 150 is configured to display a virtual keyboard interface 158 while running any application that allows a user to enter text. As with the virtual keyboard interface 148 of FIG. 1B, the third user device 150 may display the virtual keyboard interface 158, which includes a set of keys that correspond with consonants of an Indic language. The keys may be arranged in a fashion such that the consonants are laid out according to the phonetic principles described above. The virtual keyboard interface 158 may further include additional keys, such as for special characters, navigation, system commands, deleting text, modifying text, and/or the like.

In an embodiment, a user uses the virtual keyboard interface 158 to enter or type text on the third user device 150. For example, the user can select a key corresponding to a consonant using the touch interface 156 (e.g., by pressing down on the touch interface 156). Based on the selection of the key, echo key 155 may display a preview of the appropriate consonant. While the key is still selected, the user may then use the touch interface 156 to provide a gesture associated with a modifier, where the gesture originates from the selected key. Thus, the selection of the key and the gesture action may be performed by the user in one motion or stroke (e.g., a gesture that originates at a key may be considered a selection of the key and a gesture to modify a consonant associated with the key). The echo key 155 may display a preview of the modified consonant after the gesture is performed and/or until the user is no longer touching the touch interface 156 (e.g., the user releases). Based on the gesture, the third user device 150 may be configured to display the modified consonant.

### Example Process for Generating Indic Language Text

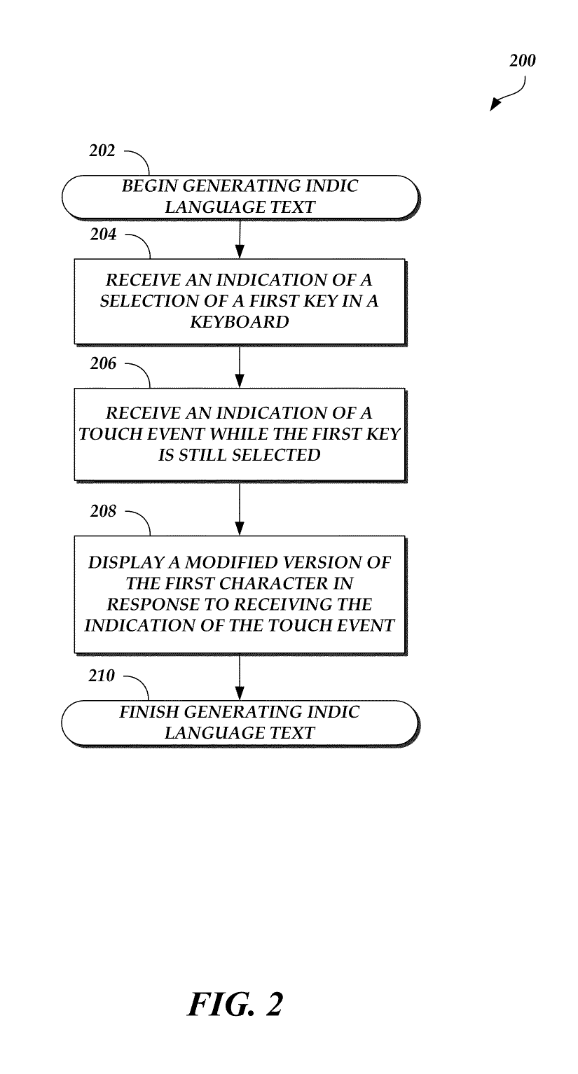

FIG. 2 illustrates an Indic language text generating process that may be implemented by a user device associated with an Indic language keyboard or keypad. As an example, the user device 110 of FIGS. 1A-1B or the third user device 150 of FIG. 1C can be configured to execute the Indic language text generating process 200. The Indic language text generating process 200 begins at block 202.

At block 204, an indication of a selection of a first key in a keyboard is received. In an embodiment, the first key is associated with a consonant of an Indic language. In further embodiments, the keyboard includes a plurality of keys, each key corresponding to a consonant of the Indic language. The first key may be selected by a user via a physical keyboard, such as the keyboard 120 of FIG. 1A, or a virtual keyboard, such as the virtual keyboard interface 148 of FIG. 1B or the virtual keyboard interface 158 of FIG. 1C.

At block 206, an indication of a touch event is received while the first key is still selected. In an embodiment, the touch event is a gesture. In further embodiments, the touch event is detected by a touch interface, such as the touch interface in the section 124 or the touch interface 128 of FIG. 1A, the touch interface 146 of FIG. 1B, or the touch interface 156 of FIG. 1C. In further embodiments, the touch event originates from a location of the first key. Thus, the selection of the key and the gesture action may be performed by the user in one motion or stroke (e.g., a gesture that originates at a key may be considered a selection of the key and a gesture to modify a consonant associated with the key). In some embodiments, a visual, audible, or sensory or haptic feedback is provided to indicate that the touch event is received.

At block 208, a modified version of the first character is displayed in response to receiving the indication of the touch event. In an embodiment, the modified version of the first character is the first character after the first character has been modified by a modifier associated with the touch event. For example, a marking may be applied to the first character to form the modified version of the first character. The modified version of the first character may be pronounced differently than the first character (e.g., a first vowel sound may be associated with the pronunciation of the first character and a second vowel sound different from the first vowel sound may be associated with the pronunciation of the modified version of the first character). In further embodiments, the modified version of the first character is displayed in response to a command received from a physical keyboard, such as the keyboard 120 of FIG. 1A, a standalone touch interface device, or another user device, such as the second user device 140 of FIG. 1B. In some embodiments, a visual, audible, or sensory or haptic feedback is provided to indicate that the touch event is received. After the modified version of the first character is displayed, the Indic language text generating process 200 may be complete, as shown in block 212.

### Example Gestures

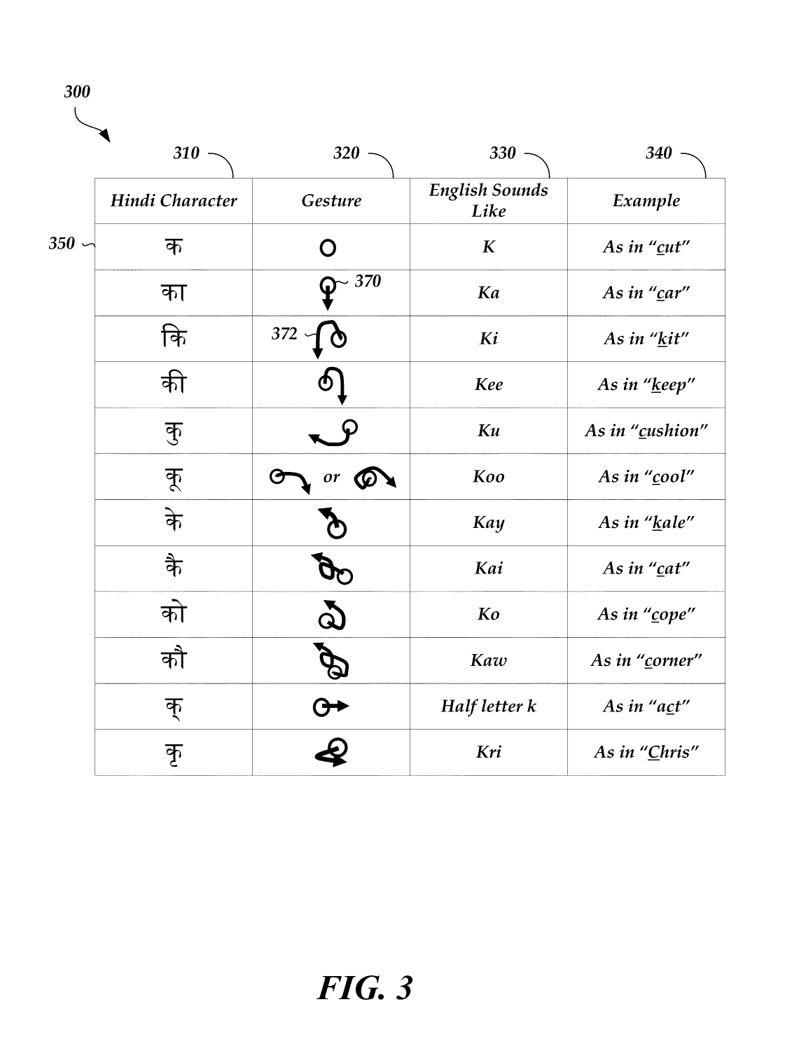

FIG. 3 illustrates a table 300 depicting gestures associated with the modification of an Indic language consonant. A user device may be programmed to display the table 300 if the user performs a predefined action (e.g., views a help menu). As illustrated in FIG. 3, the table 300 includes four columns: Hindi character column 310, gesture column 320, English sounds like column 330, and example column 340. The Hindi character column 310, in each row except for row 350, depicts a Hindi consonant that has been modified by a modifier. The Hindi character column 310 in row 350 depicts a Hindi consonant that has not been modified by any modifier. The consonant [symbol] is used here merely for illustrative purposes. The table 300 would be similar for and applies to any consonant.

The gesture column 320, in each row except for row 350, depicts a gesture that can be performed to modify a consonant in a way as depicted in the Hindi character column 310. In an embodiment, a circle, such as circle 370, represents a starting point of a gesture. As described herein, the starting point of the gesture may overlap a location of a selected key. The arrow, such as arrow 372, indicates a direction and/or path of a gesture that produces the modifier shown in the Hindi character column 310.

In some embodiments, the gestures (e.g., the directions and/or paths) are stored in a data store for later comparison with received touch events. For example, the keyboard 120, the user device 110, the second user device 140 (e.g., the application running on the second user device 140), and/or the third user device 150 may store the gestures in a data store along with their respective modifiers. When a touch event is received, the keyboard 120, the user device 110, the second user device 140 (e.g., the application running on the second user device 140), and/or the third user device 150 can compare the touch event (e.g., the direction and/or path of a detected gesture) with the stored gestures. If the touch event matches (or closely matches within a threshold) any stored gesture, an indication of the modifier associated with the stored gesture may be retrieved from the data store and the modifier may be applied to a consonant.

While the table 300 provides example gestures, this is not meant to be limiting. Other gestures, not shown, may be used to modify the depicted consonants and consonants not depicted. For example, different gestures may be provided to modify consonants in Indic languages other than Hindi in similar or different ways than as shown.

The English sounds like column 330 depicts an example of the sound used to pronounce the character depicted in the Hindi character column 310. As illustrated in row 350, the sound used to pronounce the example consonant without a modifier is “K.” As illustrated in the remaining rows, the sound used to pronounce the example consonant after the consonant has been modified varies (and specifically the vowel sound associated with the consonant varies) depending on the gesture provided (e.g., varies depending on the modifier). The example column 340 provides an illustrative example of the sound indicated in the English sounds like column 330 when used in an English word.

### Example Indic Language Keyboard Interface

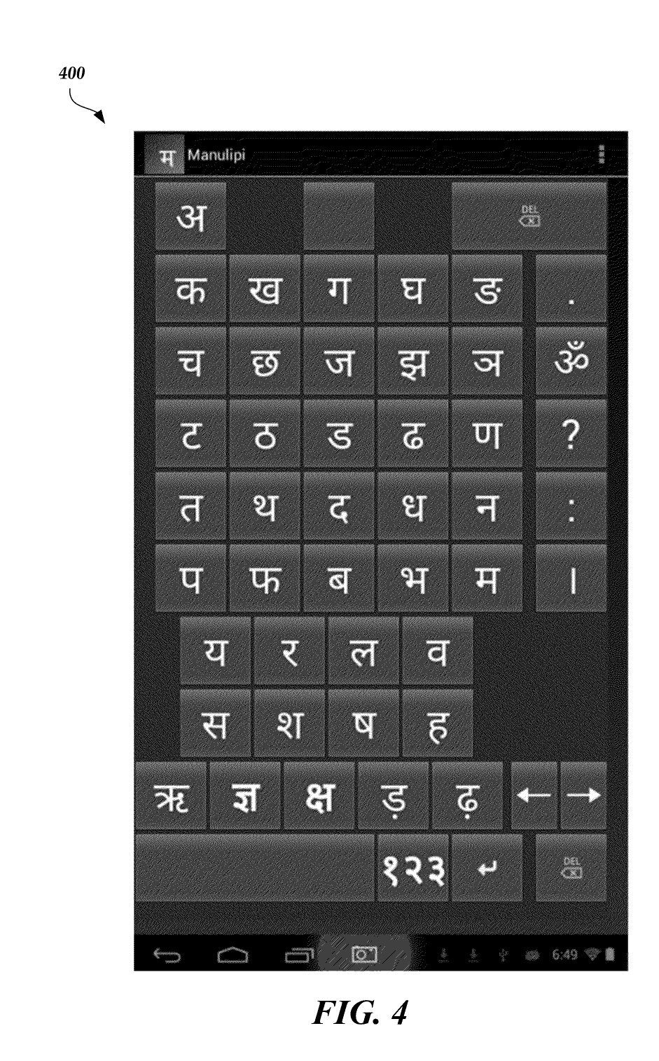

FIG. 4 illustrates an example representation of an Indic language keyboard or keypad interface 400 for use on a user device, such as the second user device 140 of FIG. 1B or the third user device 150 of FIG. 1C. As illustrated in FIG. 4, the keys of the Indic language keyboard interface 400 are laid out in a manner that comports with the phonetic principles described above. In some embodiments, a user device displays the Indic language keyboard interface 400 in a first window or area and other data (e.g., text) in a second window or area. In other embodiments, the user device displays the Indic language keyboard interface 400 such that it covers the entire screen.

As described herein, the Indic language keyboard interface 400 may be displayed on a screen that serves as a touch interface. Thus, a user may directly select any of the displayed keys. Furthermore, while a key is selected, the user may perform a gesture on or near the Indic language keyboard interface 400 to modify a selected consonant.

### Example Use Case of an Indic Language Keyboard Interface

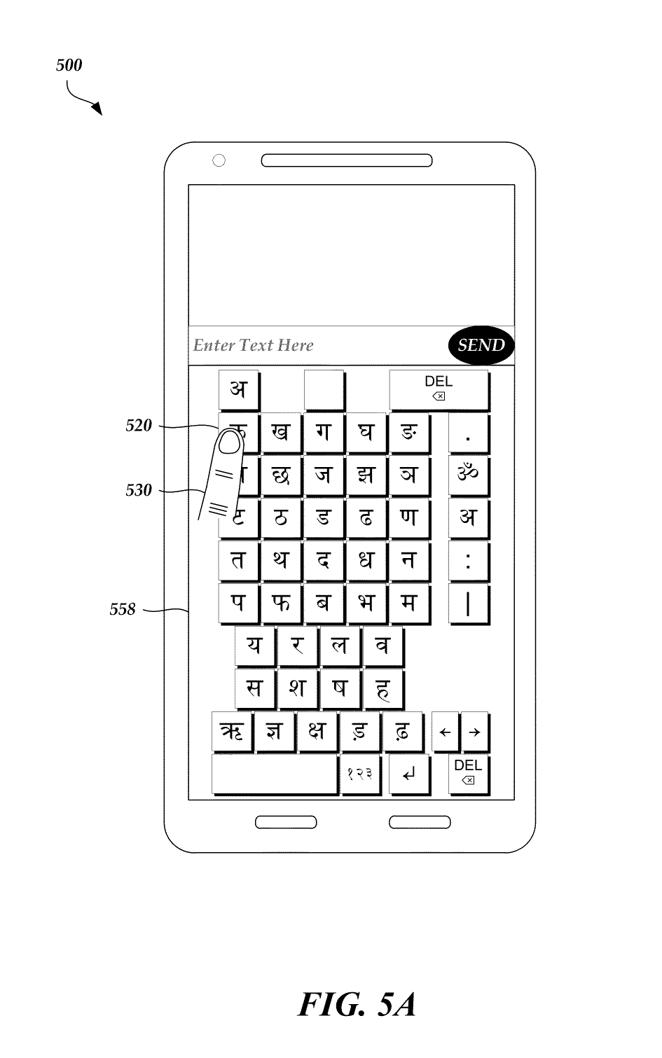

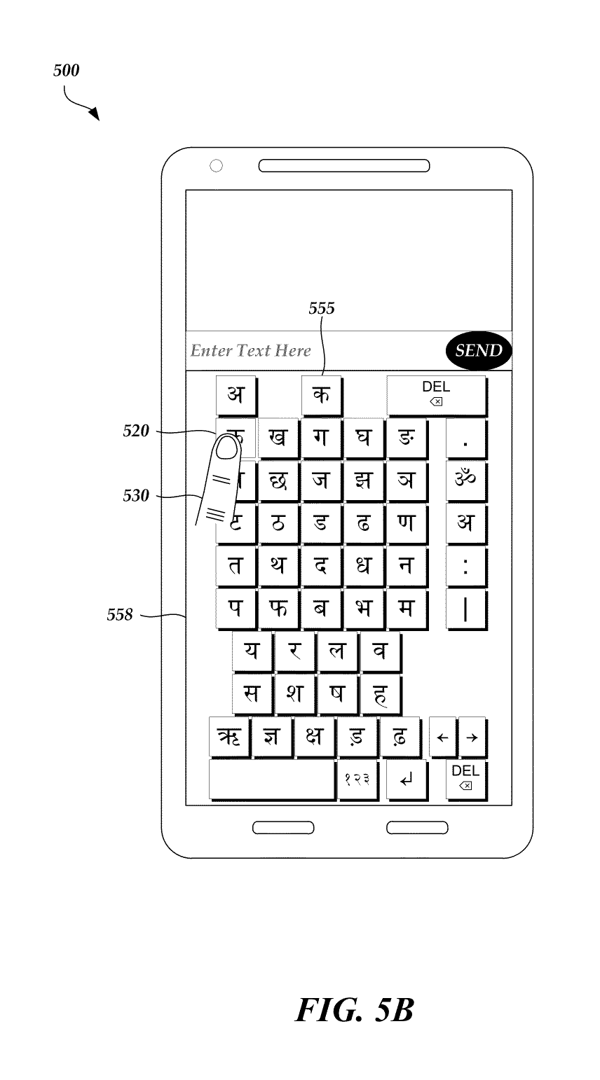

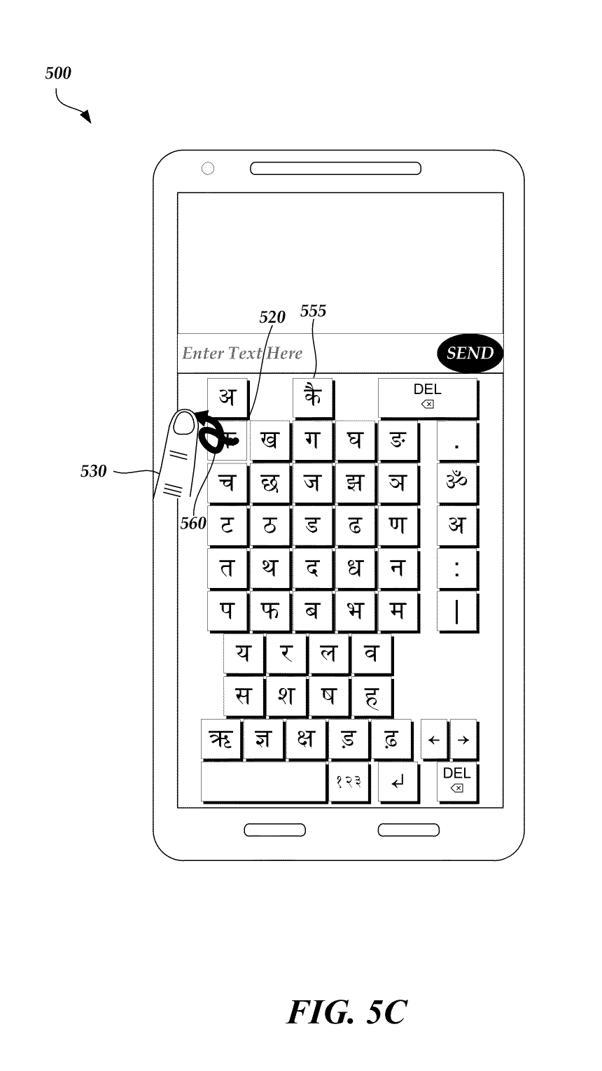

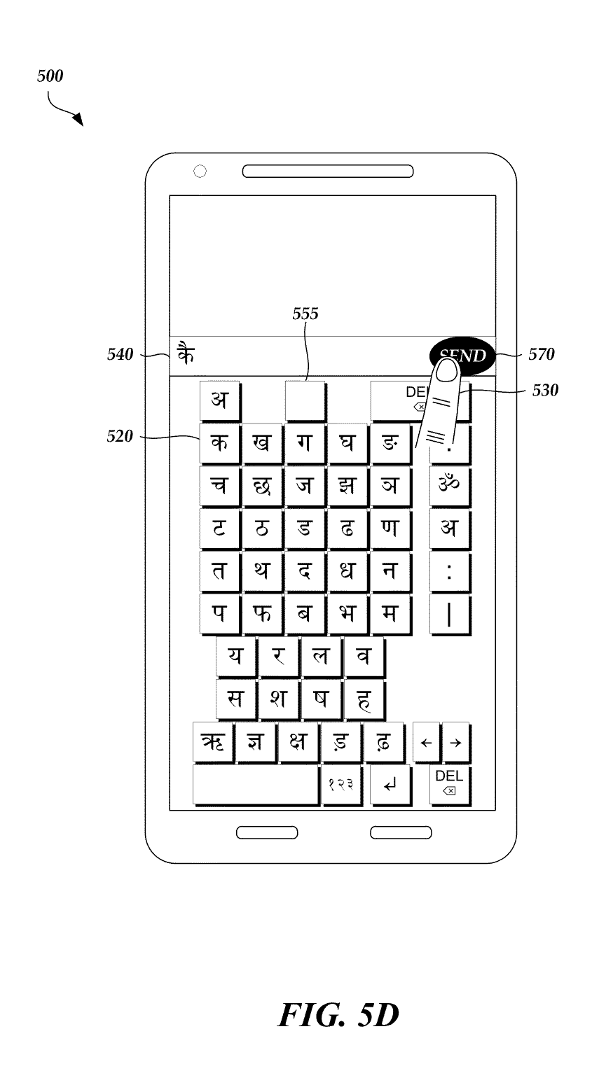

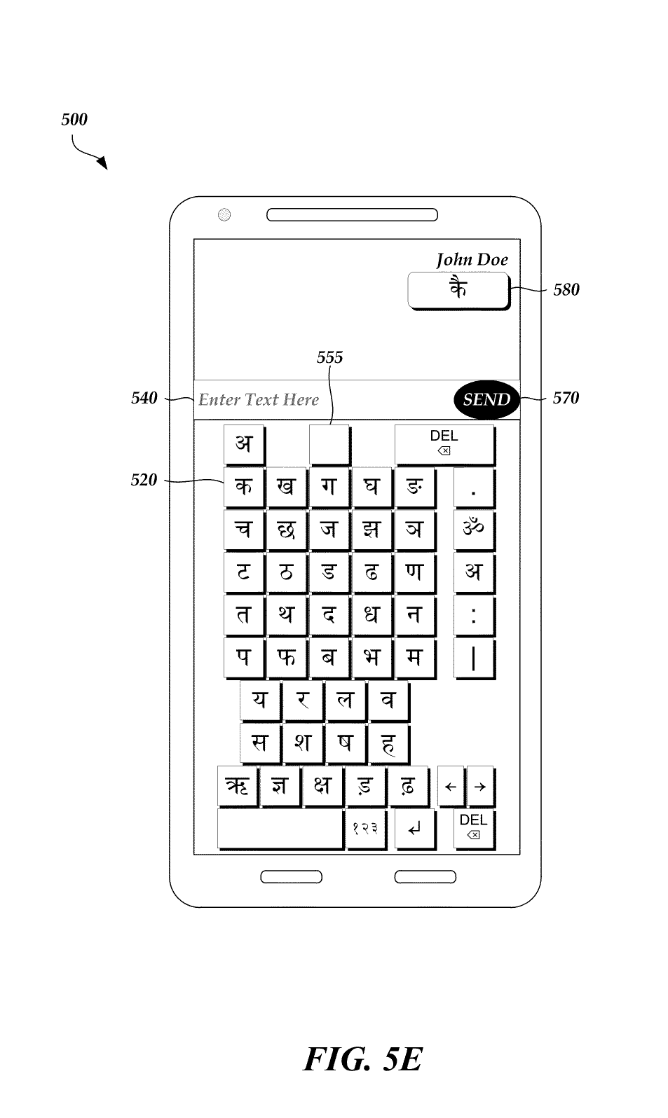

FIGS. 5A-5E illustrate an example of a user device 500 that provides an Indic language keyboard or keypad interface 558. For example, the user device 500 may be the third user device 150 of FIG. 1C. As illustrated in FIG. 5A, the user device 500 may include a touch interface 556. Using the touch interface 556, a user may select key 520 in the Indic language keyboard interface 558 using a finger 530 (or any pointing device).

As illustrated in FIG. 5B, while the user is selecting the key 520, echo key 555 may display a preview of the consonant associated with the selected key (e.g., [symbol] ). At any time after the user selects the key 520 (e.g., up until another key is selected) and while the key 520 is still selected, the user may provide a gesture to modify the consonant. As illustrated in FIG. 5C, the user performs a gesture with the finger 530. The gesture originates from the key 520 and has a direction and path represented by arrow 560.

In some embodiments, the user device 500 may query a data store to determine whether the arrow 560 matches (or closely matches with a threshold) a direction and/or path of a stored gesture. After the gesture is complete, and before the user lifts the finger 530 from the touch interface 556 such that the finger 530 no longer touches the touch interface 556, the echo key 555 may display the consonant as modified by the modifier. As illustrated in FIG. 5D, the user device 500 determines that the arrow 560 does match or closely match a stored gesture and displays a modified version of the consonant (e.g., [symbol] ) in field 540 once the finger 530 is no longer touching the touch interface 556. Furthermore, the echo key 555 may again be blank. The user may select, using the finger 530, send button 570, which removes the modified version of the consonant from the field 540 and then transmits the modified version of consonant to another user device as message 580.

### TERMINOLOGY

All of the methods and tasks described herein may be performed and fully automated by a computer system. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, and/or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on general purpose computer hardware, or combinations of both. To clearly illustrate this interchangeability of hardware and software, various illustrative components, blocks, modules, and steps have been described above generally in terms of their functionality. Whether such functionality is implemented as specialized hardware versus software running on general-purpose hardware depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A non-transitory computer-readable medium having stored thereon executable program instructions that direct a computing device to perform a process that comprises:
detecting a gesture performed by the user on a touch screen of the computing device, wherein the gesture originates at a first location on the touch screen, wherein the gesture is associated with a modifier, wherein the first location is associated with a first key of a keyboard, and wherein the first key is associated with a first character having a first sound; and
in response to the gesture, displaying a modified version of the first character, wherein the first character is modified based on the modifier associated with the gesture, and wherein the modified version of the first character has a second sound different from the first sound.

2. The non-transitory computer-readable medium of claim 1, wherein the modified version of the first character comprises a marking appended to the first character.

3. A keyboard for providing inputs to a computing device, the keyboard comprising:
a housing comprising a first cavity;
a touch interface coupled to a bottom portion of the first cavity, wherein the touch interface is configured to detect touch events provided by a user; and
a film coupled to a top portion of the touch interface, wherein the film comprises an outline of a first key associated with a first character at a first location on the touch interface, wherein the first character has a first sound, wherein the touch interface is further configured to indicate to the computing device that a modified version of the first character is selected for display in response to a detection of a gesture that originates at the first location, and wherein the modified version of the first character has a second sound different from the first sound.

4. The keyboard of claim 1, wherein the film comprises an outline of a second key at a second location on the touch interface, wherein the touch interface is further configured to indicate to the computing device that a second modified version of the first character is selected for display in place of the modified version of the first character in response to a detection of a second gesture that originates at the second location, and wherein the second modified version of the first character has a third sound different from the first sound and the second sound.

5. The keyboard of claim 1, further comprising a cable coupled to the housing, wherein the cable is configured to couple the keyboard to the computing device.

6. The keyboard of claim 5, wherein the cable is further configured to couple the keyboard to the computing device using a universal serial bus (USB) interface.

7. The keyboard of claim 1, wherein the first character is a consonant in an Indic language.

8. A computer-implemented method of generating text for display on a computing device, the method comprising:
as implemented by a mobile device comprising a touch interface, the mobile device configured with specific executable instructions,
displaying, in a first area, a keyboard, wherein the keyboard comprises a first key associated with a first character, wherein the first character is associated with a first sound, and wherein the first key is displayed at a first location on the touch interface;
receiving an indication of a touch event, wherein the touch event originates at the first location; and
displaying, in a second area, a modified version of the first character in response to receiving the indication of the touch event, wherein the modified version of the first character is associated with a second sound that is different than the first sound.

9. The computer-implemented method of claim 8, wherein the keyboard further comprises a second key displayed at a second location on the touch interface.

10. The computer-implemented method of claim 9, further comprising:
receiving an indication of a second touch event that originates at the second location; and
replacing the modified version of the first character in the second area with a second modified version of the first character in response to receiving the indication of the second touch event, wherein the second modified version of the first character is associated with a third sound that is different than the first sound and the second sound.

11. The computer-implemented method of claim 8, wherein the modified version of the first character comprises a marking appended to the first character, wherein the touch event comprises a swipe, and wherein a path of the swipe corresponds to a shape of the marking.

12. The computer-implemented method of claim 8, wherein the first character is a consonant in an Indic language.

13. The computer-implemented method of claim 12, wherein the first sound is based on a sound of the consonant and a sound of a first vowel, and wherein the second sound is based on the sound of the consonant and a sound of a second vowel.

14. A system comprising:
a network interface;
a touch interface; and
a first computing system comprising one or more computing devices, the first computing system in communication with the network interface and the touch interface and programmed to implement:
a keyboard display engine configured to display a keyboard, wherein the keyboard comprises a first key associated with a first character, wherein the first character is associated with a first sound, and wherein the first key is displayed at a first location on the touch interface;
a touch event engine configured to receive an indication of a touch event detected by the touch interface, wherein the touch event originates at the first location;
a device controller configured to instruct the network interface to transmit a command to a second computing system via a network in response to receiving the indication of the touch event, wherein the command comprises an instruction to display a modified version of the first character, and wherein the modified version of the first character is associated with a second sound that is different than the first sound.

15. The system of claim 14, wherein the keyboard further comprises a second key displayed at a second location on the touch interface, and wherein the touch event engine is further configured to receive an indication of a second touch event detected by the touch interface that originates at the second location.

16. The system of claim 15, wherein the device controller is further configured to instruct the network interface to transmit a second command to the second computing system in response to receiving the indication of the second touch event, wherein the second command comprises an instruction to replace the modified version of the first character with a second modified version of the first character, and wherein the second modified version of the first character is associated with a third sound that is different than the first sound and the second sound.

17. The system of claim 14, wherein the network interface is configured to transmit the command to the second computing device via a wireless network.

18. The system of claim 14, wherein the first computing system is further programmed to implement a device locator configured to establish a connection with the second computing system based on a physical proximity of the second computing system to the first computing system.

19. The system of claim 14, wherein the modified version of the first character comprises a marking appended to the first character.

20. The system of claim 14, wherein the first character is a consonant in an Indic language.
